(19) United States
(12) Patent Application Publication
(10) Pub. No.: US 2008/0054136 A1
(43) Pub. Date: Mar. 6, 2008

(54) Antenna with magnetic sucker

(76) Inventor: Pony Gou, TamSui (TW)

Correspondence Address: Pony Gou, P.O. Box 166-13, Taipei, 115, omitted

(21) Appl. No.: 11/512,103

(22) Filed: Aug. 30, 2006

(51) Int. Cl. F16B 47/00

(52) U.S. Cl. 248/205.5

(57) ABSTRACT

An antenna 10 with a magnetic sucker 1 is attached to a flat surface by an attractive force or an absorptive force. The antenna 10 is composed of a magnetic sucker 1, a wrapper 21, a coaxial cable 22 and a connector 23. In turn, said magnetic sucker 1 consists of a magnetic bolt disk 11 and a soft elastomer cone-shaped disk 12. One end of the coaxial cable 22 is used as a first end 22a to receive signals; the other end is a second end 22b to transmit signals. Said first end 22a includes an external conducting line 222 being exposed out and folded back to wrap around the perimeter of the external insulation layer 221, an inner insulation layer 223 exposed out of said external conducting line 222, and an inner conducting line 224 exposed out of said inner insulation layer 223.

### FIELD OF THE INVENTION

The present invention is related to a magnetic sucker, and an antenna is equipped with such a magnetic sucker incorporated in an electronic communication products. While transmitting and receiving wireless signals, such antenna can be adhered to either metallic or non-metallic surface by the same magnetic sucker.

### BACKGROUND OF THE INVENTION

The conventional sucker was attached to the surface of objects by flowing out circulated air at a bottom end thereof to produce a negative pressure relative to air pressure; thereby, a virtually vacuum attractive effect, which is ready for “air absorption”, is achieved and the sucker can be attached to a nearby flat surface.

As known, an external antenna was designed for receiving digital signals with its bottom end secured to the objects by a lock screw, or clamp, or magnet or sucker. All of them have some defects, such as a flat surface drilled with a hole fits the lock screw passed through that damages the object surface; a clamp may leave a dent and a scrap on the lacquer or object surface; a magnet may be attached to metallic surface only for a little while by lining up their atoms; and a sucker attached to a flat surface a short period by “air absorption” dependent on temperature and relative humidity. An external antenna, of course, is being fixed to the surface of objects often leaves the users a bit worried of its adherence. Surely it deserves the applicant to find a solution instead.

Frequently, an external antenna secured to the objects by magnet or sucker, but the magnet is already separated from the sucker. In other words, when an external antenna is about to fix to a non-metallic flat surface, only the bottom end of the antenna equipped with a sucker can do. Conversely, as though an external antenna is to attach to a metallic surface, preferrably in use a magnet has to be attached. Each of the magnet or sucker has specific attractive or adherence force; an antenna could have attached to a surface with an exchangeable magnet or sucker coupled to the same bottom thereof. How can we adapt both magnet and sucker to the bottom of an antenna at the same time? How to work out such a magnet incorporated into a sucker as a renewal for attaching an antenna to a flat surface promptly and efficiently. As far as it is depicted in the present invention, however, may be a proposal for a solution of such a dual function sucker.

### SUMMARY OF THE INVENTION

The present invention is to provide a magnet sucker can be attached to a metallic or non-metallic surface. To lower the labor cost and material cost, the antenna needs to be manufactured easily with a preferrable impedance match to receive signals clearly. Even the antenna can be folded telescopically and brought in person.

To solve the problems as mentioned above, the magnetic sucker 1 of the present invention is embodied by a magnetic sucker 1; especially a sucker installed to the bottom end of an antenna 10, characterized in that: a soft elastomer cone-shaped disk 12, and a magnetic bolt sucker 11 retaining magnetism hidden from view is enclosed within said soft elastomer cone-shaped sucker 12 to attract to metals.

A magnetic sucker 1 as mentioned above wherein the soft elastomer cone-shaped disk 12 includes an expandable cambered disk 121 having a protection ring 122 integrally formed with the cambered disk 121 as a whole, and the protection ring is projected inward to the center on a top of the cambered disk 121.

A magnetic sucker 1 as mentioned above wherein the magnetic bolt sucker 11 consists of a threaded bolt 111 at a top end, a disk 112 is fastened securely at a bottom end, the bolt 111 and the disk 112 are combined integrally as a whole; and the bolt 111 is exposed on the surface of the ring 122, the disk 112 hidden from view is enclosed inside the ring 122.

Next, the antenna 10 with a magnetic sucker is realized in practice, characterized in that a magnetic sucker 1 is composed of a soft elastomer cone-shaped disk 12, a magnetic bolt 11 hidden from view is enclosed inside said soft elastomer cone-shaped disk 12 with magnetism can penetrate the soft elastomer cone-shaped disk 12 to attract to metals.

A wrapper 21 is formed as a hollow tube placed onto said magnetic sucker 1, both top and bottom ends are formed with an opening.

A coaxial cable 22 is equipped with a first end 22a for receiving signals, a second end 22b for transmitting signals, said coaxial cable 22 is held on to by the wrapper 21 securely, said first end 22a is exposed out of the wrapper 21, said first end 22a includes a segment of exposed external conducting wire 222 wrapped around an external insulation layer 221, a segment of inner insulation wire 223 exposed out of said external conducting wire 222, and a segment of inner conducting wire 224 exposed out of said inner insulation layer 223.

A connector 23 is connected to the second end 22b of said coaxial cable 22 as a hot plugging support connector for transmitting signals.

An antenna 10 with magnetic sucker wherein a soft elastomer cone-shaped disk 12 is equipped with an expandable cambered disk 121 at the bottom end, a protection ring 122 formed integrally with the cambered disk 121 as a whole, and the protection ring 122 projected inward at the center on a top of the cambered disk 121.

An antenna as mentioned above, wherein the protection ring 122 has an axial hole 123 for inserting the wrapper 21 vertically therein, a hole 124 formed through a lateral side of the protection ring 122 is designed for the coaxial cable 22 passing through.

An antenna 10 as mentioned above, wherein a trough 125 is opened up and extended from the axial hole 123 to a segment of circle on the protection ring 122, said trough 125 is in communication with the axial hole 123, and a bottom end of the wrapper 21 pivoted on a transversal bolt 13 can be rotated to change angles between the axial hole 123 and the trough 125.

An antenna 10 as mentioned above, wherein the wrapper 22 is a metal pipe can be used as a grounding electrode conductor.

An antenna 10 as mentioned above, wherein the wrapper 22 is an elastomer tube insulation available applied for decoration.

### BRIEF DESCRIPTION OF THE DRAWINGS

FIG. 1: shows a cross sectional view of the magnetic sucker of the first embodiment of the present invention.

FIG. 2: shows a cross sectional view of the magnetic sucker of the second embodiment of the present invention.

FIG. 3: shows an assembled view of the antenna of the present invention.

FIG. 4: shows a cross sectional view of the antenna of the present invention.

### DESCRIPTION OF THE PREFERRED EMBODIMENTS IN DETAIL

The description is described in detail according to the appended drawings hereinafter.

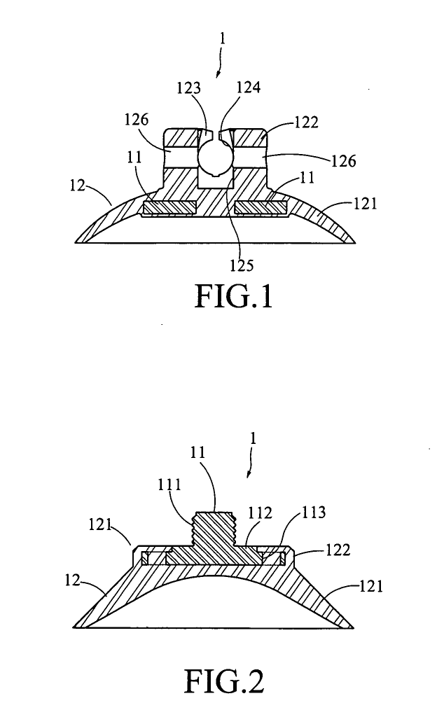

As shown in FIG. 1, a cross sectional view of the first embodiment of the present invention is illustrated. A magnetic sucker 1 is composed of a soft elastomer cone-shaped disk 12 (i.e. rubber), and a magnetic bolt disk 11; said soft elastomer cone-shaped disk 12 includes an expandable cambered disk 121 with a protection ring 122 projected inward at the center on a top of the disk 121, said cambered disk 121 and the protection ring 122 are formed integrally as a whole by injection molding; said magnetic bolt disk 11 is installed inside the cambered disk 121.

As shown in FIG. 2, a cross sectional view of the second embodiment of the present invention is illustrated. The magnetic bolt disk 11 in FIG. 2 is depicted in a different type, where the magnetic bolt disk 11 is composed of a threaded bolt 111 at a top end, and a disk 112 fastened securely to a bottom end thereof. The threaded bolt 111 and the disk 112 are formed integrally as a whole by injection modeling. The threaded bolt 111 is exposed out of the protection ring 122 to thread to an object (not shown). But the disk 112 hidden from view is enclosed inside the protection ring 122. Further, a through hole 113 formed on the disk 112 takes in unshaped liquid of the soft elastomer cone-shaped disk 12 to combine with the disk 112 integrally as a whole.

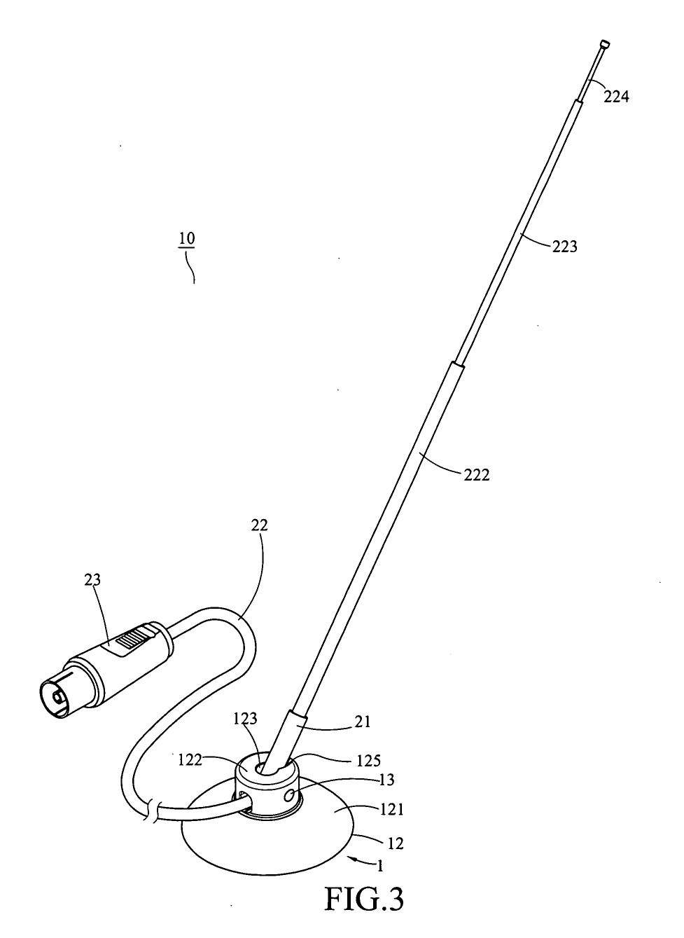

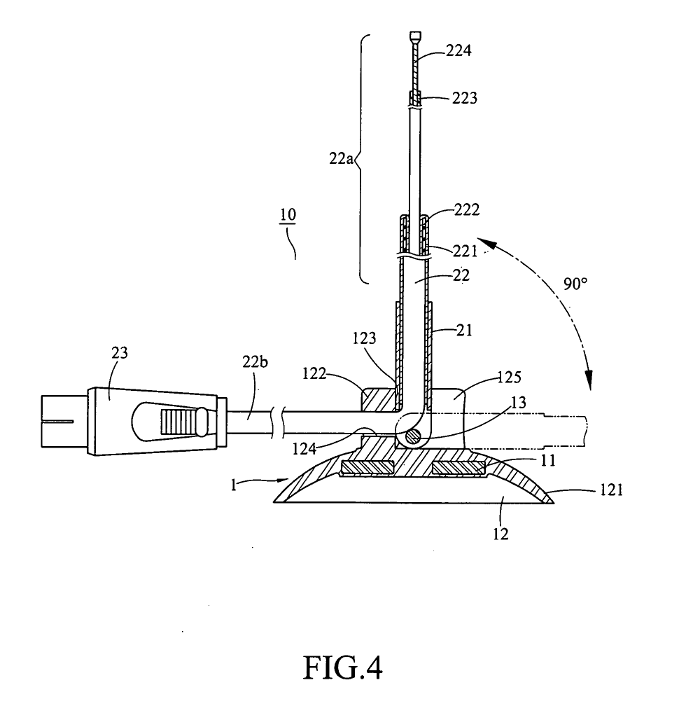

As shown in FIG. 3, an assembled view of the antenna of the present invention is illustrated. As shown in FIG. 4, a cross sectional view of the antenna with magnetic sucker is illustrated. The structure of the antenna, at least, includes a magnetic sucker 1, a wrapper 21, a coaxial cable 22, and a connector 23. In which, the magnetic sucker 1 is composed of a soft elastomer cone-shaped disk 12, a magnetic bolt disk 11 with an attractive force hidden from view is enclosed inside said soft elastomer cone-shaped disk 12. In the magnetic bolt disk 11, the attractive force can penetrate the soft elastomer cone-shaped disk 12 to attract to the metal. The wrapper 21 is a hollow pipe installed to the surface of the magnetic sucker 1. Both top and bottom ends of the wrapper 21 are formed with openings. A coaxial cable 22 has a first end 22a for receiving signals, a second end 22b for transmitting signals. The coaxial cable 22 is held on by the wrapper 21; therefore, a first end 22a of the coaxial cable is exposed out of the wrapper 21. The first end 22a includes a segment of exposed out conducting line 222 wrapped around the perimeter of the external insulation layer 221, a segment of inner layer 223 exposed out of said external conducting line 222. The connector 23 is connected to a second end 22b of said coaxial cable; the connector 23 is used as a hot plugging support connector for transmitting signals.

As mentioned above, the soft elastomer cone-shaped disk 12 has an expandable cambered disk 121 at the bottom end. A protection ring 122 is integrally formed on a top of the disk 121 as a whole by injection modeling. The protection ring 122 has an axial hole 123 at its center so that the wrapper 21 can be inserted into the axial hole vertically. The protection ring 122 also has a hole 124 formed through a lateral side thereof so that the coaxial cable can be passed through the hole 124. Next, a trough 125 is opened up being extended from the axial hole 123 to a segment of a circle along the ring 122; the trough 125 is in communication with the axial hole 123. But a bottom end of the wrapper 21 is pivoted on a transversal bolt 13, the pivotal bottom end of the wrapper 21 can be used to turn at an angle from 0° to 90° between the axial hole 123 and the trough 125.

Moreover, the wrapper 22 can be a metal pipe as a grounding electrode conductor, or an elastomer pipe insulation available applied for decoration.

In practice, the embodiments of the antenna of the present invention can achieve the advantages as following:

Magnetic sucker 1 is formed by injection modeling, in which, the magnetic bolt disk 11 and the soft elastomer cone-shaped disk 12 are combined to form integrally as a whole one magnetic sucker 1. The disk 112 of the magnetic bolt disk 11 is enclosed by the soft elastomer cone-shaped disk 12. A breadth of the soft elastomer cone-shaped disk 12 (i.e. rubber) is insufficient to interfere with the attractive force of the magnetic bolt disk 11.

Due to a bottom end of the antenna 10 is coupled to a magnetic sucker 1; therefore, the antenna 10 can be attached to a non-metal flat surface, it can also be attached to an uneven metal surface. To facilitate the “hot plugging support” function, an antenna can be realized and adapted to a surface of electronic communication products promptly and efficiently is relied on a bottom end of such an antenna equipped with only one magnetic sucker duly arrived at a metal or non-metal surface without loss.

Even when the antenna 10 is attached to a metal surface by an attractive force, but the soft elastomer cone-shaped disk 12 can also be attached to the metal surface with a virtually vacuum absorptive force. It can attach the surface of metal or non-metal for a longer duration than a conventional sucker.

What is claimed:

1. A magnetic sucker (1), especially a sucker installed to the bottom of an antenna (10), characterized in that:
a soft elastomer cone-shaped disk (12); and
a magnetic bolt sucker (11) hidden from view is enclosed in said soft elastomer cone-shaped sucker (12) with an attractive force to attract to the metals.

2. A magnetic sucker (1) as claim 1 claimed wherein the soft elastomer cone-shaped disk (12) includes an expandable cambered disk (121) with a protection ring (122) integrally formed on a top of the cambered disk (121).

3. A magnetic sucker (1) as claim 2 claimed wherein the magnetic bolt sucker (11) consists of a threaded bolt (111) at a top end, a disk (112) is fastened at a bottom end, the bolt (111) and the disk (112) are combined integrally as a whole; and the bolt (111) is exposed out of the ring (122), the disk (112) hidden from view is enclosed inside the ring (122).

4. An antenna (10) with a magnetic sucker, characterized in that:
a magnetic sucker (1) is composed of a soft elastomer cone-shaped disk (12), a magnetic bolt (11) hidden from view is enclosed inside said soft elastomer cone-shaped disk (12) with an attractive force can penetrate the soft elastomer cone-shaped disk (12) to attract to the metal;
a wrapper (21) is formed as a hollow tube placed onto said magnetic sucker (1), both top and bottom ends are formed with an opening;
a coaxial cable (22) is equipped with a first end (22a) for receiving signals, a second end (22b) for transmitting signals, said coaxial cable (22) is enclosed in the wrapper (21) securely, said first end (22a) is exposed out of the wrapper (21), said first end (22a) includes a segment of exposed out external conducting wire (222) wrapped around the perimeter of an external insulation layer (221), a segment of inner insulation wire (223) exposed out of said external conducting wire (222), and a segment of inner conducting wire (224) exposed out of said inner insulation layer (223);
a connector (23) is connected to the second end (22b) of said coaxial cable (22 ) as a hot plugging support connector for transmitting signals.

5. An antenna (10) with magnetic sucker as claim 4 claimed wherein a soft elastomer cone-shaped disk (12) is equipped with an expandable cambered disk (121) at the bottom end, a protection ring (122) is formed on a top of the cambered disk (121).

6. An antenna (10) as claim 5 claimed wherein the protection ring (122) has an axial hole (123) for receiving wrapper (21) being inserted therein, a hole (124) formed at a lateral side of the protection ring (122) for passing through the coaxial cable (22).

7. An antenna (10) as claim 6 claimed wherein a trough (125) is opened up, being extended from the axial hole (123) to a segment of a circle of the protection ring (122), said trough (125) is in communication with the axle hole (123), and a bottom end of the wrapper (21) pivoted on a transversal axle bolt (13) can be rotated to change angles between the axial hole (123) and the trough (125).

8. An antenna (10) as claim 4 claimed wherein the wrapper (22) is a metal pipe for grounding electrode conductor.

9. An antenna (10) as mentioned above, wherein the wrapper (22) is an elastomer tube insulation available applied for decoration.
